(19) United States
(12) Patent Application Publication
(10) Pub. No.: US 2003/0073431 A1
(43) Pub. Date: Apr. 17, 2003

(54) Transferring communications over a network

(76) Inventor: Jheroen Dorenbosch, Paradise, TX (US)

Correspondence Address: MOTOROLA INC, 600 NORTH US HIGHWAY 45, LIBERTYVILLE, IL, 60048-5343, US

(21) Appl. No.: 09/981,012

(22) Filed: Oct. 16, 2001

(51) Int. Cl. H04M 3/42

(52) U.S. Cl. 455/417; 455/445; 455/527

(57) ABSTRACT

An electronic device (41), method (500) and communications network (45). When the electronic device (41) is communicating with said another party's device (49) over the communications network (45), a close proximity signal received is processed when there is an identifiable electronic device (43) in close proximity thereto. In response to the close proximity signal, the device (41) determines if a transfer request signal is to be generated indicative of the identifiable electronic device (43) being a potential replacement for the electronic device (41).

### FIELD OF THE INVENTION

This invention relates to identifying a nearby replacement for an electronic device in communication with another device, over a communications network, and transferring communication to the nearby replacement. The invention is particularly useful for, but not necessarily limited to, identifying a cellular telephone's potential nearby replacement (such a conventional type telephone) and transferring a call from the cellular telephone to the potential nearby replacement.

### BACKGROUND ART

Conventional telephones, cellular telephones, desktop computers, laptop computers, Personal Digital Assistants (PDAs) and other similar electronic devices and the interconnection of those devices through such media as wired networks, wireless networks, satellite networks and the Internet allows great flexibility in the ways people acquire information and communicate with each other. For example, a person may receive a short alphanumeric message on his cellular telephone requesting an item of information. The person may use his laptop, cellular telephone or PDA to browse the Internet to find the requested information. The person may then compose an email on his laptop, cellular telephone or PDA and transmit information in response to the received short alphanumeric message.

The above electronic devices may be characterized, in part, by the specialized human interface capabilities they provide. For example, a cellular telephone may include a small display screen for displaying received messages. It may also include controls, such as switches or buttons, to allow a person operating it to connect to and navigate through the Internet. Desktop computers and laptop computers, which are typically not as portable as cellular telephones, provide sophisticated human interfaces through display screens, comprehensive keyboards, mice and other such devices.

The above electronic devices may also be characterized, in part, by their portability and the quality of communication links. For example, two conventional telephones connected through a wired network can sometimes provide a much clearer communication than two cellular telephones connected by a wireless network. It is therefore desirable to be able to selectively replace or transfer one electronic device that is involved in a call with another potentially more suitable electronic device whilst maintaining connection of the call.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided an electronic device for communication with another party's device, said electronic device comprising:

a processor; and

at least one communication unit coupled to said processor,

wherein, when said electronic device is communicating through said communication unit with said another party's device over a communications network, a close proximity signal received by said electronic device is processed when there is an identifiable electronic device in close proximity thereto, and in response to said close proximity signal said processor determines if a transfer request signal is to be generated indicative of said identifiable electronic device being a potential replacement, for said electronic device, for communicating with said another party's device over said communications network.

Preferably, said electronic device may include a user input, wherein in response to said transfer request signal an input command is requested from said user input an in response thereto said processor determines if said electronic device should communicate with said communications network to transfer said communicating, between said electronic device and said another party's device, so that said communicating is between said identifiable electronic device and said another party's device.

Suitably, said electronic device may include a display for displaying an identity of said identifiable electronic device.

Preferably, said at least one communication unit can be a single communication unit that provides said locating signal.

Alternatively, said at least one communication unit can comprise a primary communication unit and a secondary communication unit, said primary communication unit providing said communicating over said communications network and said secondary communication unit providing said locating signal. Suitably, said secondary communication unit may provide short range communication with said identifiable electronic device. The secondary communication unit may be a transceiver. Preferably, said secondary communication unit may provide communication optically. Suitably, said secondary communication unit may provide communication by short range radio frequency technology.

Preferably, in use, said processor should compare a threshold level with information associated with said close proximity signal to provide said transfer request signal, wherein said information is indicative of a distance between said electronic device and said identifiable electronic device.

Alternatively, in response to said close proximity signal said processor may determine a change in relative distance between said electronic device and said identifiable electronic device.

Preferably, in use, said processor may also compare a transfer priority rating of said identifiable electronic device with said electronic device before providing said transfer request signal.

Preferably, if said relative distance is decreasing then said processor may generate said transfer request signal if said electronic device is coupled to the communications network by a radio frequency link and said identifiable electronic device is coupled to the communications network by a wired link. Suitably, if said relative distance is increasing and said identifiable electronic device is communicating with said another party's device then said processor may generate said transfer request signal if said electronic device is connectable to the communications network by a radio frequency link and said identifiable electronic device is coupled to the communications network by a wired link. Preferably the electronic device may be a cellular telephone.

According to another aspect of the invention there is provided a method for identifying a potential replacement for the electronic device that is communicating over a communications network, the method including the steps of:

communicating between the electronic device and another electronic device over the communications network;

determining if the electronic device is in close proximity to an identifiable electronic device to thereby provide a close proximity signal;

generating a transfer request signal in response to said close proximity signal, said transfer request signal being indicative of said identifiable electronic device being a potential replacement, for said electronic device, for said communicating over said communications network with said another electronic device.

Suitably, in response to said close proximity signal the method may determine a change in relative distance between said electronic device and said identifiable electronic device.

The method may suitably include the step of comparing a call transfer priority rating of the electronic device with the identifiable electronic device before providing the transfer request signal.

Preferably, if said relative distance is decreasing then said transfer request signal is generated if said electronic device is coupled to the communications network by a radio frequency link. Suitably, if said relative distance is increasing, and said communicating is by a direct wired link to said communications network, then said transfer request signal is generated if said electronic device is connectable to the communications network by a radio frequency link. Preferably the electronic device may be a cellular telephone.

Suitably, in response to said transfer request signal, an acceptance from a user input of said electronic device may effect a transfer of said communicating, between said electronic device and said another party's device, so that said communicating is between said identifiable electronic device and said another party's device.

According to another aspect of the invention there is provided a communications network for effecting the above method.

### BRIEF DESCRIPTION OF THE DRAWINGS

In order that the invention may be readily understood and put into practical affect, reference will now be made to a preferred embodiment as illustrated with reference to the accompanying drawings in which:

FIG. 1 is a block diagram illustrating an embodiment of an electronic device in accordance with the invention;

FIG. 2 is a block diagram illustrating an embodiment of a primary communication unit forming part of the electronic device of FIG. 1;

FIG. 3 is a block diagram illustrating an embodiment of a secondary communication unit forming part of the electronic device of FIG. 1;

FIG. 4 is a schematic diagram of a plurality of electronic devices capable of communication over a telecommunications network in accordance with the invention; and

FIG. 5 is a flow diagram illustrating a method for selectively transferring the electronic device of FIG. 1 involved in a call with another electronic device.

### DETAILED DESCRIPTION OF THE PREFERRED EMBODIMENT OF THE INVENTION

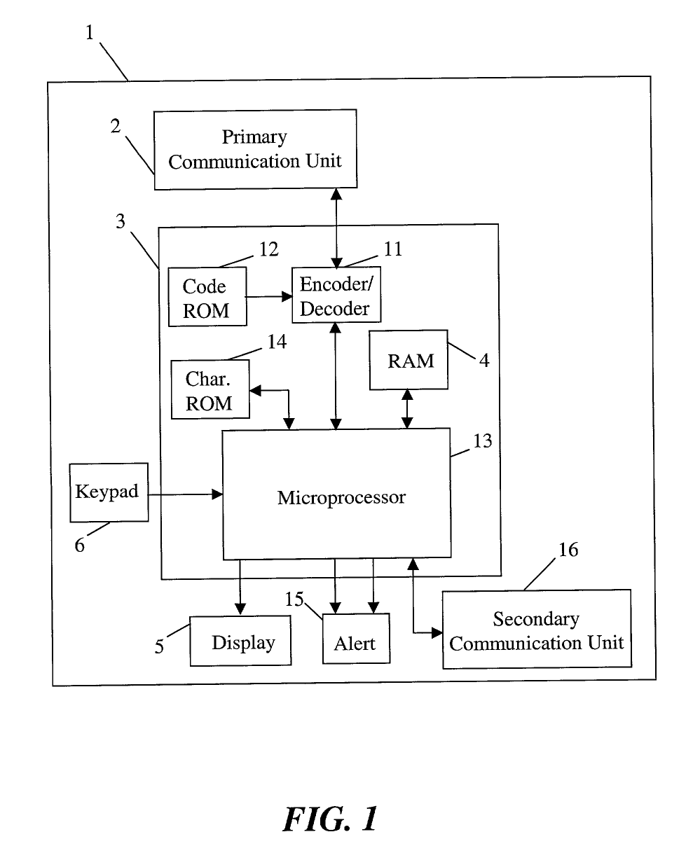

With reference to FIG. 1 there is illustrated an electronic device 1 for communicating with another party's device. The electronic device 1 comprises a primary communication unit 2 coupled to be in communication with a processor 3. A visual display unit 5 in the form of a Liquid Crystal Display and user input interface or keypad 6 are also coupled to be in communication with processor 3.

The processor 3 includes an encoder/decoder 11 with an associated Read Only Memory 12 storing data for encoding and decoding voice or other signals that may be transmitted or received by electronic device 1. The processor 3 also includes a micro-processor 13 coupled to encoder/decoder 11 and an associated character Read Only Memory 14. Micro-processor 13 is also coupled to a Random Access Memory 4, the keypad 6 and the visual display unit 5. As will be apparent to a person skilled in the art, the visual display unit 5 has an incorporated driver that is controllable by micro-processor 13. Accordingly, the visual display unit 5 is controllable by signals from the micro-processor 13 to thereby display messages and graphics. Further, auxiliary outputs of micro-processor 13 are coupled to an alert module 15 that typically contains a speaker, vibrator motor and associated drivers.

The character Read only memory 14 stores code for decoding or encoding text messages that may be received by the communication unit 2 or input at the keypad 6. In this embodiment the character Read Only Memory 14 also stores operating code (OC) for micro-processor 13. The operating code (OC) is used to run applications on the electronic device 1.

The electronic device 1 also has a secondary communication unit 16 coupled to the micro-processor 13. In this preferred embodiment, the secondary communication unit 16 allows the electronic device 1 to communicate, over a short range (typically less than 30 metres), with other identifiable electronic devices having a compatible secondary communication unit 16.

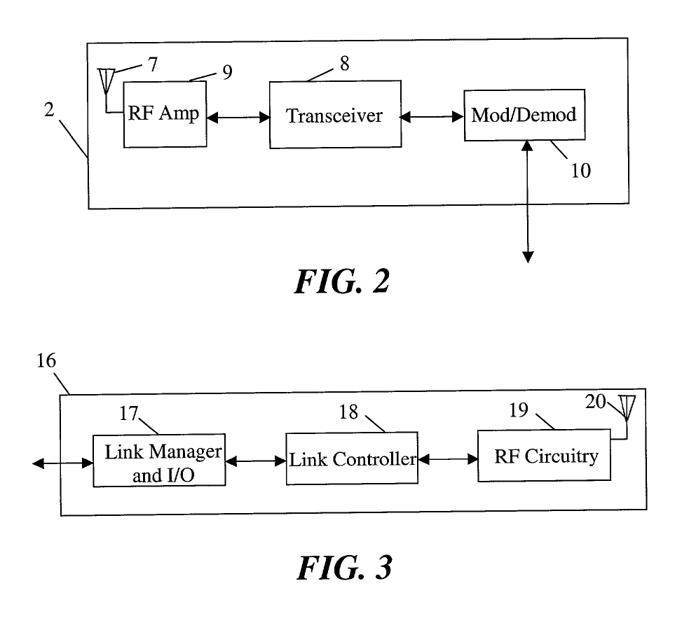

In one embodiment, illustrated in FIG. 2, the primary communication unit 2 is a combined receiver and transmitter having a common antenna 7. The communication unit 2 has a transceiver 8 coupled to antenna 7 via a radio frequency amplifier 9. The transceiver 8 is coupled to a combined modulator/demodulator 10 that couples the communication unit 2 to the processor 3.

The Secondary communication unit 16 may typically be an optical transciever (e.g. using infrared technology), or a radio communication transceiver exploiting short range frequency technology. In the case of infrared communications, the communications protocol may be established by the current Infrared Data Association (IrDA) specifications and standards available at www.irda.org.

In FIG. 3 there is illustrated a preferred embodiment of the secondary communication unit 16 in which communication is provided by a radio link in accordance with the Specification of the Bluetooth™ System, available at www.bluetooth.com, and incorporated by reference. The secondary communication unit 16 includes transmission and reception Radio Frequency circuitry 19 with an associated antenna 20, a link controller 18 and a link manager 17 for link management and interface functions with the micro-processor 13.

As will be apparent to a person skilled in the art, a frequency hop transceiver is applied to combat interference and fading. A shaped, binary FM modulation is applied to minimize transceiver complexity. The symbol rate is 1 Ms/s. A slotted channel is applied with a nominal slot length of 625 μs. For full duplex transmission, a Time-Division Duplex (TDD) scheme is used. On the channel, information is exchanged through packets. Each packet is transmitted on a different hop frequency. A packet nominally covers a single slot, but can be extended to cover up to five slots.

The Bluetooth™ protocol uses a combination of circuit and packet switching. Slots can be reserved for synchronous packets. Bluetooth™ can support an asynchronous data channel, up to three simultaneous synchronous voice channels, or a channel which simultaneously supports asynchronous data and synchronous voice. Each voice channel supports a 64 kb/s synchronous (voice) channel in each direction. The asynchronous channel can support maximal 723.2 kb/s asymmetric (and still up to 57.6 kb/s in the return direction), or 433.9 kb/s symmetric.

The electronic device 1 can be any electronic device with communication capabilities including a cellular telephone, a conventional type telephone (with a secondary communication unit 16), a desktop computer, a laptop computer or a PDA. Further, although the primary communication unit 2 in shown to use radio frequency transmission, the primary communication unit 2 may be for direct wired links (e.g. by a wired telephone link, modem wire links or internet type network links).

If the electronic device 1 is a cellular telephone, a user can select an application by actuation of keys on keypad 6. For instance, one application is that of accepting a telephone call in response to a received calling signal received by the primary communication unit 2 in which the calling signal, transmitted from a transmission source, is received by antenna 7 and then amplified by amplifier 9, filtered by transceiver 8 and demodulated by the modulator/demodulator 10. The Encoder/Decoder 11 in combination with associated Read Only Memory 12 is used, for instance, to decode the calling signal and identify the caller's identity. The micro-processor 13, Random Access memory 4 and Read Only Memory 14 then process the received calling signal and sends a control signal to the alert module 15. This therefore alerts the user that the electronic device 1 is being called. The user then has the option of accepting the call, in which the identity of the calling party is typically displayed on the visual display unit 5, by operation of one of the keys on keypad 6.

Instead of a telephone call, the electronic device 1 may receive an email message with an attachment such as a spreadsheet or picture each having different color scale resolutions. In another mode of operation, the cellular telephone 1 may process and display a received message that may be in the form of part of a video conference with a very high color scale resolution. In yet other modes of operation, the user can select an application by actuation of keys on keypad 6. Such applications may be accessing or creating spreadsheets, word processing, importing and viewing high or low color resolution graphics, sending and receiving short messages, internet browsing and making a telephone call. Accordingly, as will be apparent to a person skilled in the art, the electronic device 1 may be a 2.5G or 3G cellular telephone. As will be apparent to a person skilled in the art, similar operations can be performed if the electronic device 1 is, for example, a conventional type telephone with additional features, a desktop computer, a laptop computer or a PDA.

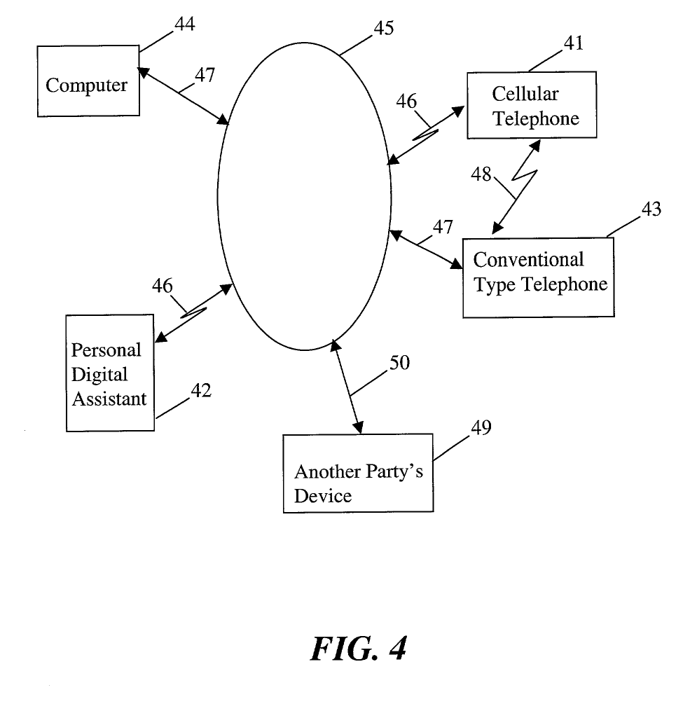

Referring to FIG. 4, there is illustrated a plurality of electronic devices 1 identified as a cellular telephone 41, a personal digital assistant 42, a conventional type telephone 43, and a desktop computer 44 all capable of communication, with another party's device 49, over a communications network 45 using their primary communication unit 2. As illustrated, the cellular telephone 41 and personal digital assistant 42 are capable of communicating over a communications network 45 by a radio frequency link 46, whereas the conventional type telephone 43 and desktop computer 44 are capable of communicating over the telecommunications infrastructure 45 by a direct wired link 47. The another party's device 49 has a link 50 with the communications network 45 that can be a direct wired link or any other suitable link. Further, as illustrated, the cellular telephone 41 and conventional type telephone 43 are in close proximity to each other and therefore can communicate by a Bluetooth™ radio frequency link 48 used by their respective secondary communication units 16.

The cellular telephone 41, personal digital assistant 42, conventional type telephone 43, and a desktop computer 44 each have a an identifier list of identifiable electronic devices that can be considered as being a potential replacement. For instance, cellular telephone 41, has an identifier list of identifiable electronic devices that are potential replacements, for the cellular telephone 41, for communicating with the another party's device 49 over the communications network 45. In this example, the cellular telephone 41 has an identifier list stored in long term memory (associated with microprocessor 13) of identifiable electronic devices that includes the personal digital assistant 42, the conventional type telephone 43, and the desktop computer 44. Also each of the of identifiable electronic devices have an associated call transfer priority rating. The identifier list and call transfer priority rating can be pre-programmed by simple use of the keypad 6 as will be apparent to a person skilled in the art.

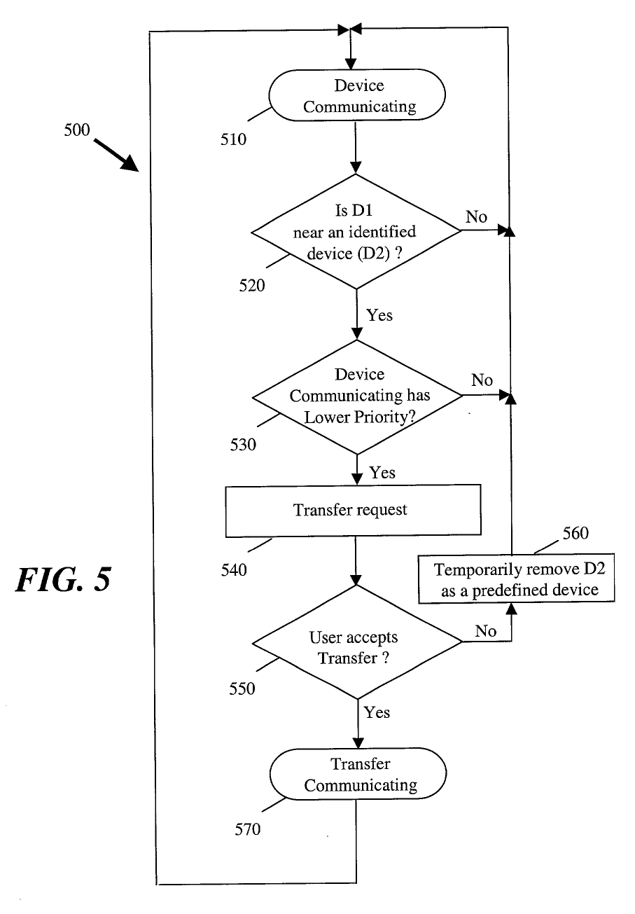

Referring to FIG. 5 there is illustrated how the processor 3 effects a method 500 for identifying a potential replacement for the electronic device 1 that is communicating over the communications network 45. In order to better understand the method 500, FIGS. 1 to 4 will also be referred to in which, by way of example, the electronic device 1 is the cellular telephone 41. The method 500 includes a step of communicating 510 in which the primary communication unit 2 of the cellular telephone 41 is in communication with the another party's device 49, over the communications network 45.

The processor 3 then effects a determining step 520 to test if the cellular telephone 41 (designated as D1) is near (in close proximity to) an identifiable electronic device 1 (designated as D2) that is listed in the identifier list of cellular telephone 41. In this embodiment, the determining step 520 relies upon the secondary communication unit 16 receiving a close proximity signal CPS from the identifiable electronic device D2 that is processed by processor 3. The determining step 520 is effected by the processor 3 comparing information indicative of a distance between D1 and D2. This is achieved by comparing a signal strength of the Bluetooth™ signal against a threshold signal strength level. Hence, in this embodiment, the close proximity signal CPS is derived from the received Bluetooth™ signal strength.

If the cellular telephone 41 designated as D1 is not near an identifiable electronic device D2 then the cellular telephone 41 keeps communicating over the communications network 45 until communication is terminated. Alternatively, if the cellular telephone 41 is near an identifiable electronic device D2 then a priority comparing step 530 is effected to determine if the electronic device communicating over the communications network 45 (at present this being electronic device D1) has a lower call transfer priority rating than the identifiable electronic device D2.

In this preferred embodiment, the identifiable electronic device D2 is the conventional type telephone 43. If the call transfer priority rating of D1 is higher or equal to that of D2 then the cellular telephone 41 keeps communicating over the communications network 45 until communication is terminated. Alternatively, if the call transfer priority rating of D1 is less than that of D2 then a transfer request step 540 is effected whereby a transfer request signal is generated by the processor 3. The transfer request signal is indicative of the identifiable electronic device D2 being a potential replacement for electronic device D1, for communicating over the communications network 45. Accordingly, the user is alerted by alert module 15 and visual display unit 5 that a call transfer may be beneficial to the user.

In this embodiment, the call transfer priority rating is dependent upon the change in the relative distance between D1 and D2. Since D1 is a cellular telephone (connectable to the communications network 45 by a radio frequency link 46) and D2 is a conventional type telephone, then when the relative distance between D1 and D2 is decreasing the priority of D2 is greater than D1. In contrast, when the relative distance between D1 and D2 is increasing then the priority of D1 is greater than D2. In other words, when D1 is connectable to the communications network 45 by the radio frequency link 46 and D2 is coupled to the communications network 45 by the direct wired link, then if the relative distance between D1 and D2 is decreasing the priority of D2 is greater than D1. Alternatively, the relative distance between D1 and D2 is increasing then the priority of D1 is greater than D2.

A user acceptance test step 550 is then effected to determine if a call transfer is required in which the identity of the device D2 (the conventional type telephone 43) is displayed on the visual display unit 5. The user therefore decides to accept or reject the call transfer request. If the user rejects the transfer then at step 560 the device D2 is temporarily removed as a identifiable electronic device from the identifier list so that annoying further transfer request steps 540 and acceptance test steps 550 and not provided for the user until after the communicating with the another party's device 49 is terminated.

After step 560, the cellular telephone 41 keeps communicating over the communications network 45 until the communicating with the another party's device 49 is terminated. However, if the user accepts the transfer request at step 550, the communicating with the another party's device 49 is transferred from device D1 to device D2 (the conventional type telephone 43) at a transfer communicating step 570. As a result, the device at communicating at step 510 is then the conventional type telephone 43. The cellular telephone 41 (device D1) therefore ceases communicating over the telecommunications infrastructure 45 with the another electronic device 49 as soon as device D2 commences communicating with the other electronic device 49. However, the cellular telephone 41 (device D1) maintains communication with the conventional type telephone 43, via the secondary communication unit 16, whilst they remain in close proximity and the method 500 continues until communications over the communications network 45 is terminated.

As will be apparent to a person skilled in the art, the transfer communicating step 570 may be effected numerous times as relative distances between D1 and D2 may increase and then decrease. This is because the user may need to move around during communicating via communications network 45. It should also be noted that transfer can be sequentially made from cellular telephone 41 to more than one of the devices 42, 43, 44, 46 during communicating via communications network 45. For example, communicating could commence via communications network 45 with the conventional type telephone 43. The communicating could then be transferred to cellular telephone 41 as relative distance therebetween increases. The communicating could then be transferred to the personal digital assistant 46 and the possibility of further transfers can occur until the communicating, via communications network 45, is terminated.

The way that the transfer communicating step 570 is effected depends on the properties of the communications network 45 and on the properties of the devices D1 and D2.

In a preferred embodiment, the cellular telephone 41 and the conventional type telephone 43 are connected to the communications network 45 which is a conventional telephone network. The processor 3 in the cellular telephone 41 obtains the telephone number of the conventional type telephone 43 via the Secondary Communication Unit, or from data programmed into the cellular telephone 41. The processor 3 in the cellular telephone 41 then sends conventional telephone call transfer commands to the communications network 45. This results in both actuation of alert 15 and a transfer request appearing on the display 5 of in the conventional type telephone 43. The user can then accept or reject the transfer request. Alternatively, the actuation of alert 15 and a transfer request appearing on the display 5 may be effected on the cellular telephone 41.

In an alternative embodiment, the devices D1 and D2 are Session Initiation Protocol (SIP) capable and are connected to communications network 45 which is IP-capable. The SIP-capable devices D1 and D2 use the SIP to set up and manage multi-media calls. SIP is part of the Internet Multimedia Conferencing Suite and is described in rfc2543 which can be obtained at www.ietf.org. For SIP devices and users are described by means of a URL. The processor 3 in the cellular telephone 41 obtains the URL with which it can set up a session with the electronic device D2, either via the Secondary Communication Unit, or from data programmed into the device D1. The processor 3 then sends a SIP INVITE message to the URL. Preferably processor 3 sends the INVITE message via the IP-capable communications network 45. The message contains information that the call is to be transferred to device D2 and on how device D2 can connect to the call. The SIP protocol specifies methods by which the SIP INVITE message is routed to device D2. The SIP protocol further specifies messages between devices D1 and D2 that result from the SIP INVITE message. As a result of the message exchange, device D2 can alert the user by alert module 15 and the visual display unit 5 and connect to the call. SIP further provides means by which device D1 can disconnect from the call.

Several other session management techniques can be used to transfer the call between devices D1 and D2. For example, IP-capable telephony devices can use the well known H.232 protocols. H.323 offers capabilities that are similar to those offered by SIP. H.3223 is a International Telecommunications Union recommendation. Detailed information can be obtained via www.itu.int.

The present invention advantageously provides for selectively replacing one electronic device 1 that is involved in a call with another potentially more suitable electronic device 1 whilst maintaining connection of the call. The user is automatically informed of a potentially more suitable electronic device 1 that is nearby to which the call can be transferred and the priority of the nearby electronic device 1 may offer benefits such as a dearer communications.

The detailed description provides a preferred exemplary embodiment only, and is not intended to limit the scope, applicability, or configuration of the invention. Rather, the detailed description of the preferred exemplary embodiment provides those skilled in the art with an enabling description for implementing a preferred exemplary embodiment of the invention. It should be understood that various changes may be made in the function and arrangement of elements without departing from the spirit and scope of the invention as set forth in the appended claims. For example, the relative distance between each of the electronic devices may be effected by a Global Positioning System (GPS) and therefore the secondary communication unit for mobile electronic devices (such as cellular telephones) would be a GPS transceiver. There would be no need for a secondary communication unit for stationary electronic devices (such as conventional type telephones). The coordinates of the identifiable stationary electronic devices would be programmed into the mobile electronic devices and relative positions and relative distances would be determined by the GPS system providing continuous updates.

We claim:

1. An electronic device for communication with another party's device, said electronic device comprising:
a processor; and
at least one communication unit coupled to said processor,
wherein, when said electronic device is communicating through said communication unit with said another party's device over a communications network, a close proximity signal received by said electronic device is processed when there is an identifiable electronic device in close proximity thereto, and in response to said close proximity signal said processor determines if a transfer request signal is to be generated indicative of said identifiable electronic device being a potential replacement, for said electronic device, for communicating with said another party's device over said communications network.

2. An electronic device, as claimed in claim 1, said electronic device including a user input, wherein in response to said transfer request signal an input command is requested from said user input an in response thereto said processor determines if said electronic device should communicate with said communications network to transfer said communicating, between said electronic device and said another party's device, so that said communicating is between said identifiable electronic device and said another party's device.

3. An electronic device, as claimed in claim 2, said electronic device including a display for displaying an identity of said identifiable electronic device.

4. An electronic device, as claimed in claim 1, wherein said communication unit is a single communication unit that provides said locating signal.

5. An electronic device, as claimed in claim 1, wherein said at least one communication comprises a primary communication unit and a secondary communication unit, said primary communication unit providing said communicating over said communications network and said secondary communication unit providing said locating signal.

6. An electronic device, as claimed in claim 5, wherein said secondary communication unit provides short range communication with said identifiable electronic device.

7. An electronic device, as claimed in claim 6, wherein said secondary communication unit is a transceiver.

8. An electronic device, as claimed in claim 6, wherein said secondary communication unit provides communication optically.

9. An electronic device, as claimed in claim 6, wherein said secondary communication unit provides communication by short range radio frequency technology.

10. An electronic device, as claimed in claim 1, wherein in use said processor compares a threshold level with information associated with said close proximity signal to provide said transfer request signal, and wherein said information is indicative of a distance between said electronic device and said identifiable electronic device.

11. An electronic device, as claimed in claim 1, wherein in response to said close proximity signal said processor determines relative distance between said electronic device and said identifiable electronic device.

12. An electronic device, as claimed in claim 1, wherein in use, said processor compares a transfer priority rating of said identifiable electronic device with said electronic device before providing said transfer request signal.

13. An electronic device, as claimed in claim 1, wherein if said relative distance is decreasing then said processor generates said transfer request signal if said electronic device is coupled to the communications network by a radio frequency link and said identifiable electronic device is coupled to the communications network by a wired link.

14. An electronic device, as claimed in claim 1, wherein if said relative distance is increasing and said identifiable electronic device is communicating with said another party's device then said processor generates said transfer request signal if said electronic device is connectable to the communications network by a radio frequency link and said identifiable electronic device is coupled to the communications network by a wired link.

15. A method for identifying a potential replacement for the electronic device that is communicating over a communications network, the method including the steps of:
communicating between the electronic device and another electronic device over the communications network;
determining if the electronic device is in close proximity to an identifiable electronic device to thereby provide a close proximity signal; and
generating a transfer request signal in response to said close proximity signal, said transfer request signal being indicative of said identifiable electronic device being a potential replacement, for said electronic device, for said communicating over said communications network with said another electronic device.

16. A method for identifying a potential replacement for the electronic device as claimed in claim 15, wherein in response to said close proximity signal the method determines relative distance between said electronic device and said identifiable electronic device.

17. A method for identifying a potential replacement for the electronic device as claimed in claim 15, the method including the step of comparing a call transfer priority rating of the electronic device with the identifiable electronic device before providing the transfer request signal.

18. A method for identifying a potential replacement for the electronic device as claimed in claim 15, wherein if said relative distance is decreasing then said transfer request signal is generated if said electronic device is coupled to the communications network by a radio frequency link.

19. A method for identifying a potential replacement for the electronic device as claimed in claim 15, wherein if said relative distance is increasing, and said communicating is by a direct wired link to said communications network, then said transfer request signal is generated if said identifiable electronic device is connectable to the communications network by a radio frequency link.

20. A method for identifying a potential replacement for the electronic device as claimed in claim 15, wherein in response to said transfer request signal, an acceptance from a user input of said electronic device effects a transfer of said communicating, between said electronic device and said another party's device, so that said communicating is between said identifiable electronic device and said another party's device.

21. A communications network including a plurality of electronic devices, the network providing:
communicating between one of the electronic devices and another electronic device over the communications network;
determining if said one of the electronic devices is in close proximity to an identifiable one of said electronic devices to thereby provide a close proximity signal;
generating a transfer request signal in response to said close proximity signal, said transfer request signal being indicative that communicating over said communications network should be transferred from said one of said one of the electronic devices to said identifiable one of said electronic devices.

22. A communications network as claimed in claim 21, wherein in response to said close proximity signal the network determines relative distance between said one of said electronic devices and said identifiable one of electronic devices.
